(19) United States
(12) Patent Application Publication
(10) Pub. No.: US 2008/0102267 A1
(43) Pub. Date: May 1, 2008

(54) METALLIC GROUNDCOAT COATING COMPOSITION

(75) Inventors: David A. McCord, Medina, OH (US); Laura J. Imm, Middlefield, OH (US); Kurt D. Bazil, Akron, OH (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: The Sherwin-Williams Company, Cleveland, OH (US)

(21) Appl. No.: 11/863,123

(22) Filed: Sep. 27, 2007

Related U.S. Application Data
(60) Provisional application No. 60/827,164, filed on Sep. 27, 2006.

(51) Int. Cl. B32B 27/00; B05D 3/00; C08K 3/08; C08K 3/10

(52) U.S. Cl. 428/323; 427/383.1; 524/435; 524/437; 524/441; 524/556; 524/560; 524/588; 524/589; 524/606

(57) ABSTRACT

A groundcoat coating composition comprising: between about 1% by weight and 10% by weight based on the total weight of the groundcoat coating composition of at least one metallic flake pigment comprising pigment particles having an average particle size in the range of 5 to 15 microns; between about 1% by weight and 10% by weight based on the total weight of the groundcoat coating composition of a second metallic flake pigment comprising pigment particles having an average particle size in the range of 15 to 50 microns; between about 1% by weight and 80% by weight based on the total weight of the groundcoat coating composition of at least one film-forming polymer resin selected from the group consisting of acrylic polymers, modified acrylic polymers, polyesters, polyepoxides, polycarbonates, polyurethanes, polyamides, polyimides, polysiloxanes, and mixtures thereof; and between about 1% and 50% by weight based on the total weight of the groundcoat coating composition of a topcoat coating composition. A method of forming a coating on a substrate comprising applying the groundcoat coating composition to the substrate. Also, a coated substrate comprising the groundcoat coating composition.

### CROSS-REFERENCE TO RELATED APPLICATION

This application claims the benefit of U.S. provisional patent application No. 60/827,164 filed on Sep. 27, 2006, the entirety of which is hereby incorporated by reference.

Automotive basecoats and topcoats having metallic, pearlescent and opalescent color effects are achieved by the introduction of finely divided metallic flake or mica particles into one or more layers of the coating system. While many of these systems provide unique and desirable color and special appearance effects, improvements in hiding and color matching in aftermarket and refinish applications are constantly being sought. To obtain an acceptable color match to these OEM color styles, diminished hiding results, which subsequently requires a significant number of coats to achieve acceptable hiding and acceptable color match.

According to this invention, a highly pigmented neutral groundcoat coating composition is used to obtain hiding of the topcoat color in much fewer spray applications. The groundcoat coating composition of this invention is blended with the topcoat color to shift the groundcoat coating composition color to be closer to the actual topcoat color required to match the intended OEM color of the topcoat composition to be applied. Because this coating composition is neutral in color position, the addition of the topcoat color moves the undertone of the coating composition to the color position of the actual topcoat color to be applied. The result is that much fewer coats of the topcoat color will be required to obtain color match and hiding, thus reducing the number of topcoats required by as much as 50-75%. When the topcoat is applied over the metallized groundcoat of this invention, a much reduced film thickness of the topcoat composition is required. Thus, it is an object of the instant invention to provide a groundcoat coating composition that provides a hiding and color match in metallic coatings in much fewer topcoat applications.

Metallic groundcoat coating compositions according to this invention comprise a combination of metallic flake pigments comprising pigment particles having at least two differing average particle sizes. The use of these metallic flake pigments of differing particle sizes enhances the hiding of metallic groundcoats. The metallic pigments of the invention also enhances dry time, OEM certification, sprayability, and blendability.

Thus, it is another object of the invention to provide a method of forming a coating on a substrate comprising: (I) applying to the surface of the substrate as a groundcoat a pigmented coating composition comprising:
(a) between about 1% by weight and 10% by weight based on the total weight of the groundcoat coating composition of at least one metallic flake pigment comprising pigment particles having an average particle size in the range of 5 to 15 microns;
(b) between about 1% by weight and 10% by weight based on the total weight of the groundcoat coating composition of a second metallic flake pigment comprising pigment particles having an average particle size in the range of 15 to 50 microns;
(c) between about 1% and 80% of a polymer resin selected from the group consisting of acrylic polymers, modified acrylic polymers, polyesters, polyepoxides, polycarbonates, polyurethanes, polyamides, polyimides, polysiloxanes, and mixtures thereof.
   (II) allowing the composition applied in step (I) to at least partially dry or cure to form a pigmented groundcoat on the substrate surface;
   (III) applying a film forming topcoat composition over the pigmented groundcoat of step (II); and
   (IV) allowing the topcoat composition of step (III) to at least partially dry or cure to form a topcoat over said groundcoat.

According to this invention, there is provided an automotive groundcoat composition comprising metallic pigments. The groundcoat composition comprises between about 1% by weight and 10% by weight of a metallic pigment comprising pigment particles having an average particle size of 5 to 15 microns; and between about 1% and 10% by weight of a metallic pigment comprising pigment particles having an average particle size of 15 to 50 microns. The groundcoat composition also includes at least one film-forming polymer binder resin, and further comprises a film-forming topcoat composition.

A suitable film-forming polymer binder will generally be one or more polymer resins or oligomers having active hydrogen-containing functional groups. Such groups include, for example, hydroxyl groups, amino groups, thiol groups, hydrazide groups, carbamate groups, activated methylene groups, and mixtures thereof. Such polymer resins include, for example, acrylic polymers, modified acrylic polymers, polyesters, polyepoxides, polycarbonates, polyurethanes, polyamides, polyimides, polysiloxanes, and mixtures thereof, all of which are known in the art. In an embodiment of this invention, the polymer can be an acrylic, modified acrylic or polyester.

In one example of the invention, the polymer resin is an acrylic resin. Acrylic resins refer to the generally known addition polymers and copolymers of acrylic and methacrylic acids and their ester derivatives, acrylamide and methacrylamide, and acrylonitrile and methacrylonitrile. Examples of ester derivatives of acrylic and methacrylic acids include alkyl acrylates and alkyl methacrylates such as ethyl, methyl, propyl, butyl, hexyl, ethylhexyl and lauryl acrylates and methacrylates, as well as similar esters, having up to about 20 carbon atoms in the alkyl group. Also, hydroxyalkyl esters can readily be employed. Examples of such hydroxyalkyl esters include 2-hydroxyethyl acrylate, 2-hydroxypropyl acrylate, 2-hydroxyethyl methacrylate, 2-hydroxypropyl methacrylate, 3-hydroxypropyl methacrylate, 4-hydroxybutyl methacrylate, and mixtures of such esters having up to about 5 carbon atoms in the alkyl group. Where desired, various other ethylenically unsaturated monomers can be utilized in the preparation of acrylic resins, examples of which include: vinyl aromatic hydrocarbons such as styrene, alpha-methyl styrene, vinyl toluene, alpha-chlorostyrene; non-aromatic mono-olefinic and di-olefinic hydrocarbons such as isobutylene, 2,3-dimethyl-1-hexene, 1,3-butadiene, chlorethylene, chlorobutadine and the like; and esters of organic and inorganic acids such as vinyl acetate, vinyl propionate, isopropenyl acetate, vinyl chloride, allyl chloride, vinyl alpha chloracetate, maleic acid and its monoesters, dimethyl maleate and the like.

In another example of this invention, the polymer resin is a polyurethane or polyurea resin. Polyurethane or polyurea resins refer to the generally known thermosetting resins prepared from organic polyisocyanates and organic compounds containing active hydrogen atoms as found for example in hydroxyl, and amino moieties, respectively. Some examples of polyurethane resins typically utilized in coating compositions include the isocyanate-modified alkyd resins. Examples of systems based on polyurethane resins typically utilized as two-pack coating compositions include an organic polyisocyanate or isocyanate-terminated prepolymer in combination with a substance containing active hydrogen as in hydroxyl or amino groups together with a catalyst (e.g. organotin salt such as dibutyltin dilaurate). The active hydrogen-containing substance in the second pack typically is a polyester polyol, a polyether polyol, or an acrylic polyol known for use in such two-pack urethane resin systems. Another example of a polyurethane resin is a one pack system with blocked polyisocyanate and/or isocyanurates that unblock at high temperatures. Hydroxyl terminated polyurethanes are also used as a crosslinkable resin.

Polyester resins having active hydrogen groups such as hydroxyl groups can also be used as the polymer resin in the composition according to the invention. Polyester resins are generally known and are prepared by conventional techniques utilizing polyhydric alcohols and polycarboxylic acids. Examples of suitable polyhydric alcohols include, without limitation, ethylene glycol, propylene glycol, diethylene glycol, dipropylene glycol, butylene glycol, neopentyl glycol, glycerol, trimethylolpropane, pentaerythritol, sorbitol, 1,6-hexanediol, 1,4-cyclohexanediol, 1,4-cyclohexanedimethanol, and 1,2-bis(hydroxyethyl)cyclohexane. Examples of suitable polycarboxylic acids include, without limitation, phthalic acid, isophthalic acid, terephthalic acid, trimellitic acid, tetrahydrophthalic acid, hexahydrophthalic acid, tetrachlorophthalic acid, adipic acid, azelaic acid, sebacic acid, succinic acid, malic acid, glutaric acid, malonic acid, pimelic acid, succinic acid, 2,2-dimethylsuccinic acid, 3,3-dimethylglutaric acid, 2,2-dimethylglutaric acid, maleic acid, fumaric acid, and itaconic acid. Moreover, polyesters are intended to include polyesters modified with fatty acids or glyceride oils of fatty acids (i.e. conventional alkyd resins). Alkyd resins typically are produced by reacting the polyhydric alcohols, polycarboxylic acids, and fatty acids derived from drying, semi-drying, and non-drying oils in various proportions in the presence of a catalyst such as sulfuric acid, or a sulfonic acid to effect esterification. Examples of suitable fatty acids include saturated and unsaturated acids such as stearic acid, oleic acid, ricinoleic acid, palmitic acid, linoleic acid, linolenic acid, licanic acid and oleostearic acid.

Polyurethanes having active hydrogen functional groups are also well known in the art. They are prepared by a chain extension reaction of a polyisocyanate (e.g., hexamethylene diisocyanate, isophorone diisocyanate, MDI, etc.) and a polyol (e.g., 1,6-hexanediol, 1,4-butanediol, neopentyl glycol, trimethylol propane). They can be provided with active hydrogen functional groups by capping the polyurethane chain with an excess of diol, polyamine, amino alcohol, or the like.

Examples of metallic flake pigments include, without limitation, aluminums, micas, gold bronze (copper-zinc alloys), copper, nickel, silver, brass, magnesium, zinc, and alloys of these. Flake pigments are usually available in fine, medium, and coarse grades. Aluminums are used in one embodiment of this invention. Commercial aluminum flake pigments are available from many sources, including Eckart, (Louisville, Ky.) under the tradename STAPA; Silberline (Tamaqua, Pa.) under the tradenames SPARKLE SILVER or TUFFLAKE.; and Toyo Aluminum KK (Higashiku, Osaka, Japan). The metallic flake pigments may be predispersed separately or together prior to blending with the polymer resins of the invention. The amount of metallic flake pigment and polymer vary according to the pigment used and is readily determined by one skilled in the art to optimize dispersion characteristics or properties of the pigment concentration. The metallic flake pigments should be processed in a way that avoids bending or breaking the flakes. The groundcoat composition according to this invention comprises at least one metallic flake pigment comprising pigment particles having average particle size of 5-15 microns, and a second metallic flake pigment comprising pigment particles having average particle size of 15-50 microns. The at least one metallic flake pigment and the second metallic flake pigment can be the same or different The metallic pigments are uniformly dispersed in the polymer resin matrix. The proportion of the metallic pigment is about 1 to 10 percent by weight of metallic pigments having average particle size of 5-15 microns, and 1 to 10 percent by weight of metallic pigments having average particle size of 15-50 microns, based on the weight of the groundcoat composition.

The groundcoat coating composition further comprises a film-forming topcoat coating composition. The topcoat coating composition can be virtually any topcoating composition known to those skilled in the art, and can be waterborne or solventborne, or, alternatively, in solid particulate form, i.e., a powder coating. The groundcoat coating composition comprises about 1% and 50% by weight based on the total weight of the groundcoat coating composition of the topcoat coating composition.

The groundcoat composition of the invention can optionally include other additives such as rheology control agents, matting agents, surfactants, stabilizers, wetting agents, dispersing agents, adhesion promoters, fillers, UV absorbers, hindered amine light stabilizers, antioxidants, foaming agents, and mixtures of these additives, and so on. The total amount of additive may be up to 50% by weight of the composition, depending on what additives are used.

UV absorbers, hindered amine light stabilizers, and antioxidants are usually used in low levels, for example from about 0.025% to about 5% by weight of the composition. Examples of UV absorbers include benzophenones and benzotriazoles, available commercially from a number of sources, including BASF Corp., Mt. Olive, N.J.; CYTEC Industries, West Patterson, N.J.; Ciba-Geigy Corp., Hawthorne, N.Y.; and Witco Corp., Greenwich, Conn. Hindered amine light stabilizers are also available commercially, for example from CYTEC and Ciba-Geigy. Antioxidants include alkylated phenols and bisphenols, alkylidene polyphenols, and other phenolic derivatives; organic phosphites and phosphates; hydroquinone and its derivatives; and various other compounds known to be useful as antioxidants.

The groundcoat composition can also include one or more solvents. In general, the solvent can be any organic solvent or solvents suitable for the polymer resin(s). The solvent or solvents may be selected from aliphatic solvents or aromatic solvents, for example, ketones, esters, acetates, toluene, xylene, aromatic hydrocarbon blends, or a combination of any of these. In one embodiment, the solvent is selected from polar aliphatic solvents or polar aromatic solvents. More specifically, the solvent is a ketone, ester, acetate, aprotic amide, aprotic sulfoxide, aprotic amine, or a combination of any of these. Examples of useful solvents include, without limitation, methyl ethyl ketone, methyl isobutyl ketone, amyl acetate, ethylene glycol monobutyl ether acetate, propylene glycol monomethyl ether acetate, xylene, N-methylpyrrolidone, blends of aromatic hydrocarbons, and mixtures of these.

The groundcoat of the invention is spray-applied to a desired area of the substrate and cured. The coating composition includes one or more of the crosslinkable resins having reactive functional groups and one or more crosslinking agents which have functional groups which are reactive with those of the resins, including at least one of the crosslinkers of the invention. After application onto the substrate, the coating composition is cured thermally and can also be cured by the application of radiation, for example by infrared or ultraviolet radiation. The thermal curing and the radiation curing steps may be carried out simultaneously. Alternatively, the thermal curing step may occur prior to the radiation curing step, or the radiation step may be carried out before the thermal curing step. Basically, according to this invention, thermal curing begins immediately after application of the coating composition onto the substrate. In general, it is preferred that the thermal curing step be carried out at least in part before the radiation (such as ultraviolet exposure) treatment is begun.

Radiation curing is carried out by exposing the curing composition to radiation, preferably in the form of infrared radiation or ultraviolet radiation. For ease of use and for cost considerations, ultraviolet radiation is preferred. When ultraviolet radiation is used to cure the coating compositions, it is common to include in the coating compositions an accelerator which will promote the formation of radicals from the double bonds present in the crosslinking composition. After the applied groundcoat layer is allowed to dry, a topcoat composition is then applied in a layer over the groundcoat composition layer.

### EXAMPLES

In general, the groundcoat coating compositions of this invention can be prepared according to the formulations given in Tables I-II. The percent figures are given as percent by weight.

TABLE I
General Formula of Groundcoat Composition

| | Range of Composition, |
|---|---|
| Raw Material | by Weight % |
| Polymeric Resin Component | 1-80 |
| (for example: acrylic polymers, modified | |
| acrylic polymers, polyesters, polyepoxides, | |
| polycarbonates, polyurethanes, polyamides, | |
| polyimides, polysiloxanes, and mixtures thereof) | |
| Topcoat Coating Composition | 1-50 |
| (for example: waterborne, solventborne, | |
| powder coating) | |
| Metallic Flake Pigment | 1-10 |
| (ave. particle size 5-15 microns) | |
| Metallic Flake Pigment | 1-10 |
| (ave. particle size 15-50 microns) | |
| Rheology Control Additive | 0-5 |
| Color Dispersant | 0-10 |
| Antisettling Agent | 0-5 |
| Organic Solvent (MAK) | 0-80 |
| Organic Solvent (MPK) | 0-80 |
| Solvent C | 0-30 |
| Flow Additive | 0-5 |
| UV Absorber | 0-5 |
| Hindered Amine Light Stabilizer | 0-5 |
| Accelerator | 0-5 |
| Catalyst | 0-5 |

### Example 1

### Preparation of Groundcoat Coating Compositions

Commercially available polymer resin compositions (such as a standard acrylic/melamine, polyester, a blocked isocyanate polyurethane, two-component isocyanate polyurethane, etc.) (all commercially available from BASF Corporation of Southfield, Mich.) are combined with 1-10% of a first commercially available metallic pigment comprising pigment particles having an average particle size of 5-15 microns, and a second commercially available metallic pigment comprising pigment particles having an average particle size of 15-50 microns. The first and second metallic pigments can be the same or different—for example, the first metallic pigment can be aluminum pigment, and the second can be zinc, for example. The composition containing polyurethane, polyester, melamine, (etc.) resin and pigmented with metallic flakes is then mixed at a ratio of 2:1 with the topcoat coating composition to be applied. The mixture is then reduced to the recommended viscosity according to the manufacturer's specifications to obtain sprayable viscosity.

### Example 2

### Preparation of a Coated Substrate

One coat of the groundcoat composition is applied and blended/faded into the substrate of the properly repaired OEM finish. The groundcoat composition can be dried at room temperature, ultraviolet or infrared radiation. The substrate coated in this way is then spray coated over the groundcoat with the topcoat coating composition of the substrate. Complete hiding is achieved in one or two coats of the topcoat.

We claim:

1. A groundcoat coating composition comprising:
(a) between about 1% by weight and 10% by weight based on the total weight of the groundcoat coating composition of at least one metallic flake pigment comprising pigment particles having an average particle size in the range of 5 to 15 microns;
(b) between about 1% by weight and 10% by weight based on the total weight of the groundcoat coating composition of a second metallic flake pigment comprising pigment particles having an average particle size in the range of 15 to 50 microns;
(c) between about 1% and 80% by weight based on the total weight of the groundcoat coating composition of a polymer resin selected from the group consisting of acrylic polymers, modified acrylic polymers, polyesters, polyepoxides, polycarbonates, polyurethanes, polyamides, polyimides, polysiloxanes, and mixtures thereof; and
(d) between about 1% and 50% by weight based on the total weight of the groundcoat coating composition of the topcoat coating composition.

2. The coating composition of claim 1, wherein at least one polymer resin is an acrylic resin, and wherein the acrylic resins is between about 1% by weight and 80% by weight based on the total weight of the groundcoat coating composition

3. The coating composition of claim 1, wherein at least one polymer resin is a polyester resin at least one polyester resin is between about 1% by weight and 80% by weight based on the total weight of the groundcoat coating composition.

4. The coating composition of claim 1, wherein the at least one metallic flake pigment is selected from the group consisting of aluminum, mica, gold bronze, copper, zinc, nickel, silver, brass, magnesium, and alloys of aluminum, mica, copper, zinc, nickel, silver, brass, magnesium.

5. The coating composition of claim 1, wherein the second metallic flake pigment is selected from the group consisting of aluminum, mica, gold bronze, nickel, silver, brass, magnesium, and alloys of aluminum, mica, copper, zinc, nickel, silver, brass, magnesium.

6. The coating composition of claim 1, wherein the at least one metallic flake pigment and the second metallic flake pigment are the same or different.

7. A coated substrate comprising a cured coating composition comprising:
(a) a groundcoat coating composition comprising:
(a) between about 1% by weight and 10% by weight based on the total weight of the groundcoat coating composition of at least one metallic flake pigment comprising pigment particles having an average particle size in the range of 5 to 15 microns;
(b) between about 1% by weight and 10% by weight based on the total weight of the groundcoat coating composition of a second metallic flake pigment comprising pigment particles having an average particle size in the range of 15 to 50 microns;
(c) between about 1% and 80% by weight based on the total weight of the groundcoat coating composition of a polymer resin selected from the group consisting of acrylic polymers, modified acrylic polymers, polyesters, polyepoxides, polycarbonates, polyurethanes, polyamides, polyimides, polysiloxanes, and mixtures thereof; and
(d) between about 1% and 50% by weight based on the total weight of the groundcoat coating composition of a topcoat coating composition.

8. A method of forming a two-layered coating on a substrate comprising:
(I) applying to the surface of the substrate as a groundcoat a pigmented coating composition comprising
(a) between about 1% by weight and 10% by weight based on the total weight of the groundcoat coating composition of at least one metallic flake pigment comprising pigment particles having an average particle size in the range of 5 to 15 microns;
(b) between about 1% by weight and 10% by weight based on the total weight of the groundcoat coating composition of a second metallic flake pigment comprising pigment particles having an average particle size in the range of 15 to 50 microns;
(c) between about 1% and 80% of a polymer resin selected from the group consisting of acrylic polymers, modified acrylic polymers, polyesters, polyepoxides, polycarbonates, polyurethanes, polyamides, polyimides, polysiloxanes, and mixtures thereof; and
(d) between about 1% and 50% of a topcoat coating composition, wherein said topcoat coating composition is a film-forming polymer; and
(II) allowing the composition applied in step (I) to at least partially dry or cure to form a pigmented groundcoat on the substrate surface;
(III) applying a film-forming topcoat coating composition over the groundcoat of step (II); and
(IV) allowing the topcoat coating composition of step (III) to at least partially dry or cure to form a topcoat over said groundcoat.
